(19) United States
(12) Patent Application Publication
(10) Pub. No.: US 2018/0218242 A1
(43) Pub. Date: Aug. 2, 2018

(54) INFORMATION PROCESSING APPARATUS, INFORMATION PROCESSING METHOD, AND COMPUTER-READABLE STORAGE MEDIUM

(71) Applicant: Oki Electric Industry Co., Ltd., Tokyo (JP)

(72) Inventor: Masatoshi SEKINE, Tokyo (JP)

(73) Assignee: Oki Electric Industry Co., Ltd., Tokyo (JP)

(21) Appl. No.: 15/886,796

(22) Filed: Feb. 1, 2018

(30) Foreign Application Priority Data
Feb. 2, 2017 (JP) 2017-017413

(51) Int. Cl. G06K 9/62; G06N 3/08

(52) U.S. Cl. CPC G06K 9/6267; G06K 9/629; G06N 3/08

(57) ABSTRACT

An information processing apparatus, including (1) a classification device configured to classify a state of an observation target using a learning result based on sensor information received from a multiple sensor terminals; and (2) a transmission control model constructing device configured to determine a necessity for transmission of sensor information for each sensor terminal based on communication cost of sensor information and classification accuracy of the classification device, wherein the classification device classifies the state of the observation target based on sensor information transmitted based on the necessity of transmission determined by the transmission control model constructing device.

### TECHNICAL FIELD

The present invention relates to an information processing apparatus, an information processing method, and a computer-readable storage medium.

### BACKGROUND ART

In recent years, with the development of technology, various sensor devices for detecting a state of a target (for example, machine tools, industrial robots, and industrial products) have been developed. Many methods have been proposed for determining the state of a target using sensor information acquired by the sensor device and for controlling the operation of various devices based on the determined state.

According to Japanese Patent Application Laid-Open (JP-A) No. 2005-337965, for example, a diagnostic device for diagnosing an abnormality of a rotating machine is disclosed. The diagnostic device of the rotary machine includes a detection sensor, a plurality of low-pass filters having different cutoff frequencies, and a diagnosis means (for example, a Personal Digital Assistant).

Japanese Patent Application Laid-Open (JP-A) No. 2006-79279 discloses a classification system that improves classification accuracy by adjusting parameters such as a sampling frequency, and a predetermined band division number in a frequency domain, using reinforcement learning.

In a network standardized by IEEE 802.15.4e, a method for optimizing communication parameters on a Media Access Control (MAC) layer by reinforcement learning is disclosed (for example, see H. Kapil, C. S. R. Murthy, “A Pragmatic Relay Placement Approach in 3-D Space and Q-Learning-Based Transmission Scheme for Reliable Factory Automation Applications” IEEE Systems Journal, Mar. 3, 2016 Volume: PP, Issue 99, pp. 1-11 (referred to as Document 1 hereafter)).

In addition, a technique of approximating an output of a value function related to a next command in a computer game by a method combining a convolution neural network and reinforcement learning is disclosed (for example, see V. Mnih et al., “Human-level control through deep reinforcement learning”, Nature, Feb. 25, 2015, 518.7540, pp. 529-533 (referred to as Document 2 hereafter)).

In a technique described in JP-A No. 2006-79279, detection of a state based on sensor information and control of transfers to a data collection device are not taken into consideration. Further, the technique described in JP-A No. 2006-79279 does not consider the trade-off between communication costs and classification accuracy.

In the technique described in Document 1, optimization of parameters in the upper layer is not taken into consideration. Further, the technique described in Document 2 does not consider transmission control on autonomous distributed sensor terminals or reinforcement learning based on rewards including parameters in trade-off relationship such as classification accuracy and communication costs.

### SUMMARY OF THE INVENTION

The present invention provides a technique capable of largely reducing the communication cost of sensor information while maintaining classification accuracy.

The invention relates to an information processing apparatus, which includes (1) a classification device configured to classify a state of an observation target using a learning result based on sensor information received from a plurality of sensor terminals; and (2) a transmission control model constructing device configured to determine a necessity for transmission of sensor information for each sensor terminal based on communication cost of sensor information and classification accuracy of the classification device. The classification device classifies the state of the observation target based on sensor information transmitted based on the necessity of transmission determined by the transmission control model constructing device.

The invention also relates to an information processing method, which includes (1) discriminating the state of an observation target using a learning result based on sensor information received from a plurality of sensor terminals; and (2) determining the necessity for transmission of sensor information for each sensor terminal based on communication cost of sensor information and classification accuracy related to the observation target. The discriminating includes discriminating the state of the observation target based on sensor information transmitted based on the necessity of transmission determined.

The invention also relates to a computer-readable storage medium storing computer-executable program instructions, execution of which by a computer causes the computer to classify the state of an observation target. The program instructions include (1) instructions to discriminating a state of an observation target using a learning result based on sensor information received from a plurality of sensor terminals; and (2) instructions to determining the necessity for transmission of sensor information for each sensor terminal based on communication cost of sensor information and classification accuracy related to the observation target. The discriminating includes discriminating the state of the observation target based on sensor information transmitted based on the determined necessity of transmission.

### BRIEF DESCRIPTION OF THE DRAWINGS

FIG. 1 illustrates an example of a system configuration according to a first embodiment of the invention.

FIG. 2 illustrates a case in which all sensors provided in a plurality of sensor terminals transmit sensor information in all time zones according to the first embodiment of the invention.

FIG. 3 illustrates an example of sensor information transmitted by the sensor terminal based on a transmission control model according to the first embodiment of the invention.

FIG. 4 illustrates an example of a functional block diagram of the sensor terminal according to the first embodiment of the invention.

FIG. 5 illustrates an example of a functional block diagram of the information processing apparatus according to the first embodiment of the invention.

FIG. 6 is a flowchart illustrating a flow of an operation of the information processing apparatus in a learning data collection phase according to the first embodiment of the invention.

FIG. 7 illustrates an example of feature vectors extracted by a feature vector extraction unit according to the first embodiment of the invention.

FIG. 8 is a diagram relating to an input of the state correct value according to the first embodiment of the invention.

FIG. 9 is a flowchart illustrating a flow of an operation of the information processing apparatus in a transmission control model construction phase according to the first embodiment of the invention.

FIG. 10 is a diagram relating to a difference in classification accuracy of a combination of sensor terminals according to the first embodiment of the invention.

FIG. 11 illustrates an operation model of reinforcement learning according to the first embodiment of the invention.

FIG. 12 is an example illustrating a value function Q at time t in a table format according to the first embodiment of the invention.

FIG. 13 is a flowchart illustrating a flow of an operation of the information processing apparatus in the state classification phase according to the first embodiment of the invention.

FIG. 14 illustrates a network configuration example of a neural network used for approximating a value function in constructing a transmission control model according to a second embodiment of the invention.

FIG. 15 is a flowchart illustrating a flow of an operation of the information processing apparatus in a learning data collection phase according to the second embodiment of the invention.

FIG. 16 illustrates an example of a hardware configuration of the information processing apparatus according to the invention.

### DESCRIPTION OF THE EMBODIMENTS

The embodiments of the present invention will be described in detail with reference to the accompanying drawings. In the specification and drawings, components having substantially the same functions and configurations will be referred to using the same or similar reference numerals, and duplicated description thereof will be omitted.

### (1) First Embodiment

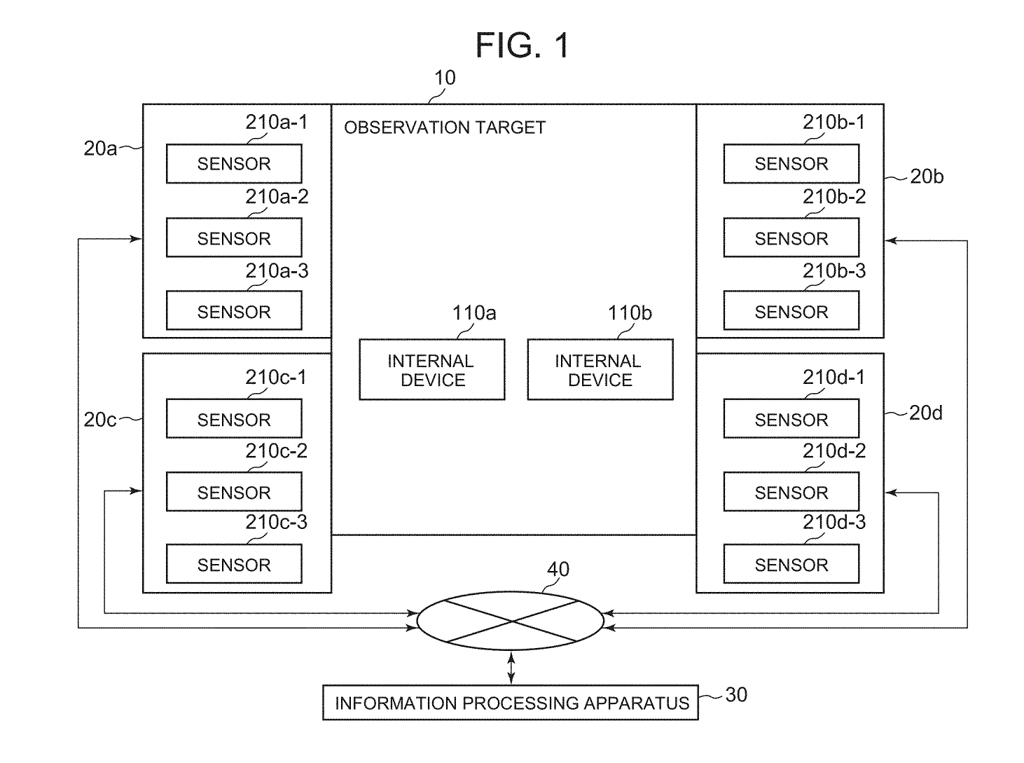

FIG. 1 illustrates the example of the system configuration according to the first embodiment of the invention. An information processing system according to the present embodiment includes an observation target 10, a plurality of sensor terminals 20 (i.e. 20a-20d), and an information processing device 30. Further, the plurality of sensor terminals 20 and the information processing device 30 are connected via a network 40.

The observation target 10 is a target of state determination by the information processing device 30. For example, the observation target 10 may be any of various devices and products in a factory, electronic devices installed in companies and homes and the like. Also, the observation target 10 may include buildings, bridges, and roads. In addition, the observation target 10 includes one or more internal devices 110 to be the acquisition target of sensor information by the sensor terminal 20. In FIG. 1, the observation target 10 includes internal devices 110a and 110b.

Each of the sensor terminal 20a-20d is a terminal that collects various kinds of sensor information from the internal device 110 of the observation target 10. Generally, the sensor terminal is limited in physical and spatial observation range. Therefore, as shown in FIG. 1, the plurality of sensor terminals 20 may be arranged for one observation target 10. In FIG. 1, four sensor terminals 20a to 20d are arranged for the observation target 10.

Further, since each of the sensor terminals 20a-20d can collect various kinds of sensor information related to the internal device 110 of the observation target 10, each of the sensor terminals 20a-20d may include a plurality of sensors 210 as shown in FIG. 1. For example, the plurality of sensors 210 may include a vibration sensor, an acoustic sensor, a heat sensor, an illuminance sensor, an image sensor or the like. By including the plurality of sensors 210 as described above, the sensor terminal 20 can capture different physical characteristics according to the operating state of the observation target 10. For example, the operating state is processing state, waiting state, and power-off state or the like.

The information processing apparatus 30 is a device that classifies the state of the observation target 10 based on sensor information transmitted from the plurality of sensor terminals 20. The information processing apparatus 30 may perform the above determination in real time. That is, when a change occurs in the state of the observation target 10, the sensor terminal 20 immediately transmits sensor information corresponding to the change in the state to the information processing apparatus 30. The information processing apparatus 30 can each time output the state determination result based on the sensor information transmitted from the sensor terminal 20.

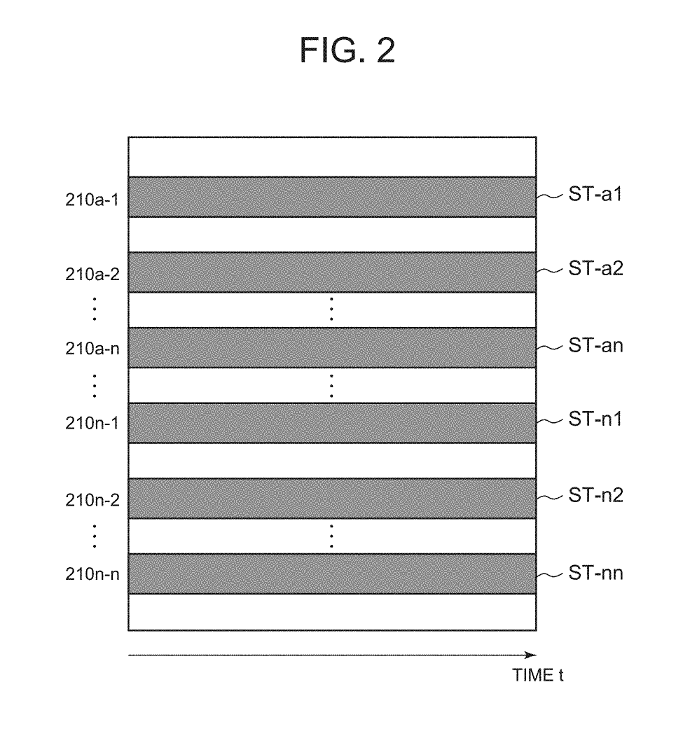

As shown in FIG. 2, the plurality of sensors 210a-1 to 210n-n may transmit collected sensor information ST-a1 to ST-nn to the information processing device 30 in all time zones. All time zones mean that the sensors transmit the sensor information at all time. However, depending on the state of the observation target 10, it is often the case that sufficient accuracy can be determined with sensor information obtained only from some of the plurality of sensors 210 of the plurality of sensor terminals 20. In addition, as shown in FIG. 2, when all the sensors 210 transmit sensor information in all time zones, the bandwidth in wireless communication is wasted unnecessarily.

Therefore, in the first embodiment, by securing sensor information necessary for discriminating the state, classification accuracy is maintained, and when required, the necessary sensor terminal 20 may transmit the sensor information collected by the necessary sensor 210. Specifically, the information processing apparatus 30 according to the first embodiment constructs a transmission control model for determining whether to transmit sensor information based on communication cost and classification accuracy for each sensor terminal and sensor type. The sensor terminal 20 may transmit sensor information based on the transmission control model.

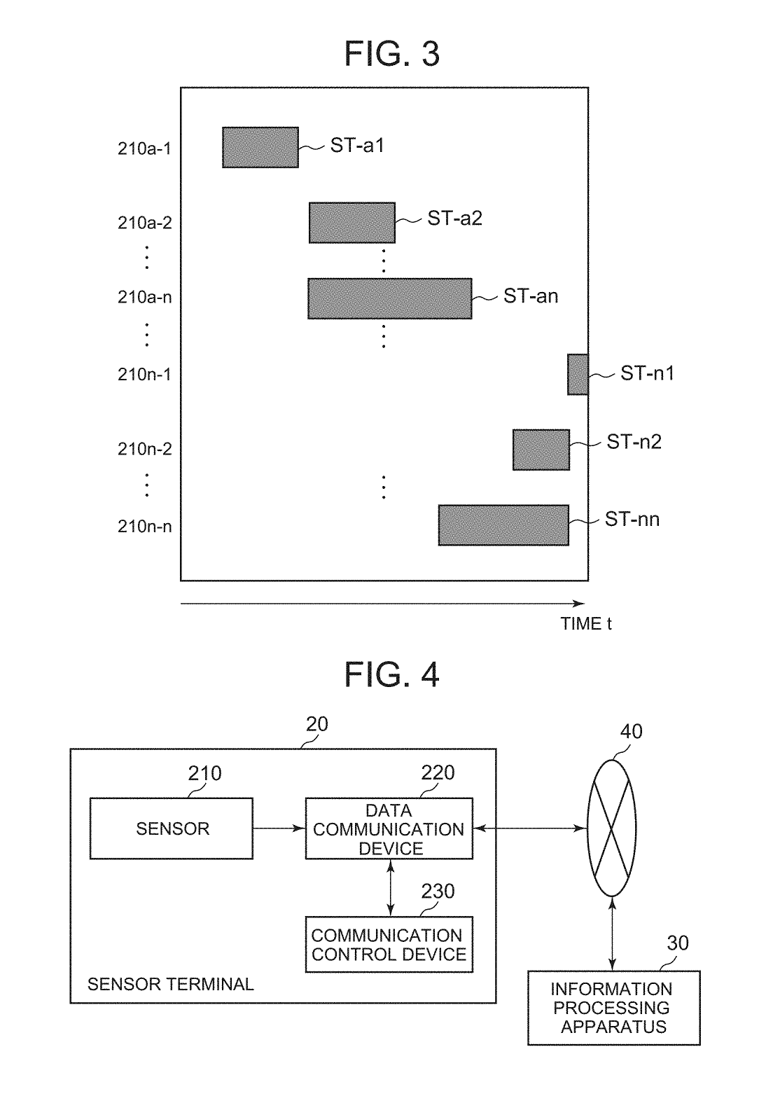

FIG. 3 illustrates an example of sensor information transmitted by the sensor terminal 20 based on a transmission control model according to the first embodiment of the invention. As shown in FIG. 3, the sensor terminals 20a to 20n transmit sensor information collected by the sensors 210a-1 to 210n-n included therein to the information processing device 30 at different timings. At this time, the sensor terminals 20a to 20n may transmit sensor information based on the transmission control model constructed by the information processing device 30. That is, the sensor terminal 20 can transmit only sensor information necessary for state classification by the information processing device 30 at necessary timing.

The system configuration described with reference to FIG. 1 is merely an example, and the system configuration according to the first embodiment is not limited to this example. For example, FIG. 1 shows an example in which the observation target 10 includes two internal devices 110a and 110b and four sensor terminals 20a to 20d are arranged. However, the number of the internal device 110 and the sensor terminal 20 are not limited to this example. In addition, a plurality of sets of the observation targets 10 and the sensor terminals 20 may exist. The system configuration according to the first embodiment is flexibly changed according to characteristics of observation targets, specifications of the network 40 and the like.

Next, an example of a functional configuration of the sensor terminal 20 will be described. FIG. 4 is a functional block diagram of the sensor terminal 20. The sensor terminal 20 includes a sensor 210, a data communication device 220, and a communication control device 230.

The sensor 210 has a function of collecting sensor information relating to the internal device 110 of the observation target 10. The sensor terminal 20 may include a plurality of sensors 210. Further, for example, the sensor 210 may include a vibration sensor, an acoustic sensor, a thermal sensor, an illuminance sensor, an image sensor or the like. The sensor terminal 20 may include various sensors 210 according to the characteristics of the observation target 10.

The data communication device 220 has a function of transmitting sensor information to the information processing apparatus 30 under the control of the communication control device 230. In this case, when the sensor information collected by the sensor 210 is an analog signal, the data communication device 220 may convert the analog signal into a digital signal and transmit the digital signal to the information processing apparatus 30. Further, the data communication device 220 transmits various kinds of information related to the sensor terminal 20 to the information processing apparatus 30. For example, the above information may include an identifier for identifying the sensor terminal 20, information on the battery remaining amount of the sensor terminal 20 or the like.

The communication control device 230 has a function of causing the data communication device 220 to transmit sensor information based on the transmission control model constructed by the information processing device 30. Specifically, based on the transmission control model, the communication control device 230 determines whether transmission of sensor information is necessary for each sensor 210 of the sensor terminal 20, and controls data communication.

The above-described functional configuration described with reference to FIG. 4 is merely an example, and the functional configuration of the sensor terminal 20 is not limited to this example. For example, the communication control device 230 may be provided outside the sensor terminal 20. Further, the sensor terminal 20 may further have a configuration other than that shown in FIG. 4. For example, the sensor terminal 20 may further include an input unit that accepts an operation by the user, a storage unit that stores sensor information or the like. The functional configuration of the sensor terminal 20 may be flexibly changed.

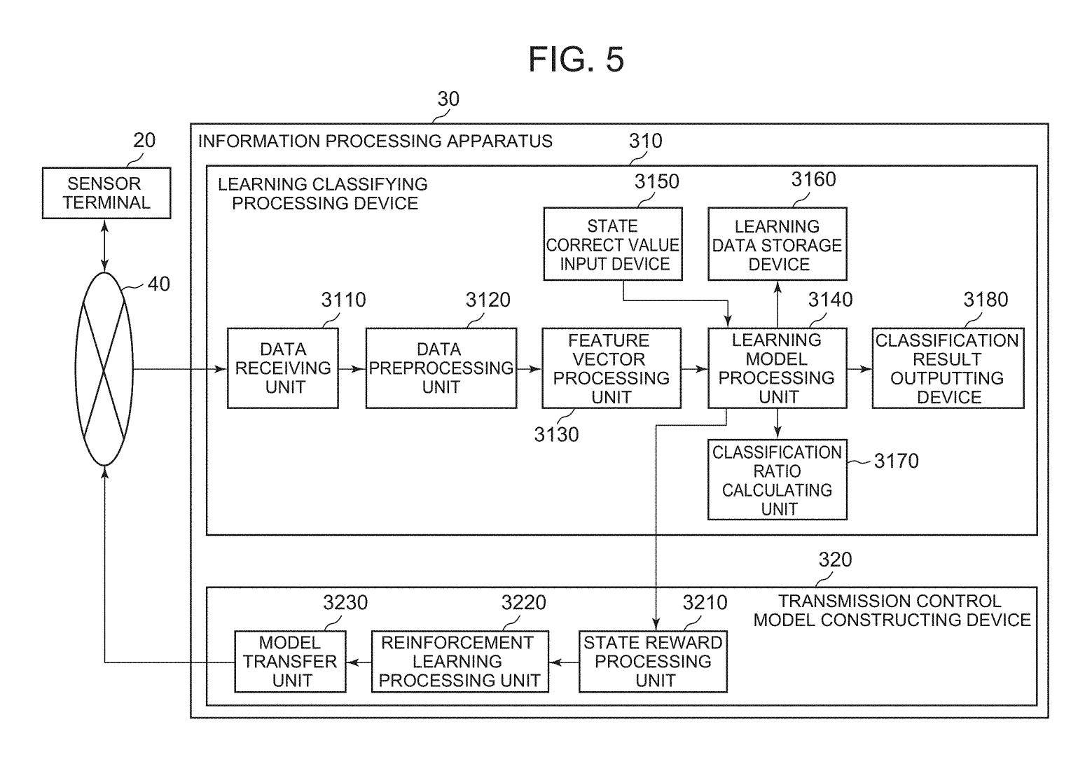

Next, an example of a configuration of the information processing apparatus 30 will be described. FIG. 5 is a functional block diagram of the information processing apparatus 30. The information processing apparatus 30 includes a learning classifying processing device 310 and a transmission control model constructing device 320.

The learning classifying processing device 310 has a function of performing learning related to the state determination of the observation target 10 based on sensor information received from the sensor terminal 20 and the state correct value input by the user. In addition, the learning classifying processing device 310 functions as a classification device that classifies the state of the observation target 10 using the above learning result. At this time, the learning classifying processing device 310 may determine the state of the observation target 10 based on sensor information transmitted based on the transmission necessity determined by the transmission control model constructing device 320 described later. For this purpose, as shown in FIG. 5, the learning classifying processing device 310 includes a data receiving unit 3110, a data preprocessing unit 3120, a feature vector processing unit 3130, a learning model processing unit 3140, a state correct value input device 3150, a learning data storage device 3160, a classification ratio calculating unit 3170, and a classification result outputting device 3180.

The data receiving unit 3110 has a function of receiving sensor information from the plurality of sensor terminals 20 via the network 40. Further, the data receiving unit 3110 may receive various kinds of information related to the sensor terminal 20 together with the above-described sensor information.

The data preprocessing unit 3120 has a function of performing preprocessing relating to sensor information received by the data receiving unit 3110. For example, the above preprocessing may include noise removal filtering, power spectrum using a Fourier transform, measurement value conversion such as a spectrogram or the like. The data preprocessing unit 3120 may perform various processes according to the characteristics of the sensor information to be received.

The feature vector processing unit 3130 has a function of extracting a feature vector relating to sensor information from sensor information processed by the data preprocessing unit 3120. At this time, the feature vector processing unit 3130 can extract the feature vector according to the characteristics of sensor information. For example, when sensor information is vibration data or acoustic data, the feature vector processing unit 3130 may extract a feature vector by combining a dominant frequency in a frequency domain, an average frequency or the like. In addition, the feature vector processing unit 3130 may use sensor information processed by the data preprocessing unit 3120 as a feature vector.

The learning model processing unit 3140 has a function of constructing a learning model for discriminating the state of the observation target 10 based on the feature vector extracted by the feature vector processing unit 3130 and the state correct value input by the user. In this case, the learning model processing unit 3140 may construct the learning model using various methods and algorithms used in the field of machine learning. In addition, the learning model processing unit 3140 may classify the state of the observation target 10 based on a constructed learning model and an extracted feature vector.

The state correct value input device 3150 has a configuration for inputting the name and label of the state of the observation target 10 currently being observed. The above input may be performed based on an input operation by the user. The state correct value input device 3150 includes one or more input devices such as a keyboard, a mouse, buttons, switches, and a touch panel.

The learning data storage device 3160 has a function of combining and storing a feature vector extracted from sensor information transmitted from each sensor terminal 20 and a state correct value input via the state correct value input device 3150. For example, the learning data storage device is Hard Disc Drive (HDD) or the like.

The classification ratio calculating unit 3170 has a function of calculating a classification ratio relating to the state classification from the correctness or incorrectness of classification at the time of input to the above learning model for a plurality of states of learning data in a certain state of the observation target 10.

The classification result outputting device 3180 has a function of presenting the result of classification by the learning model processing unit 3140 to the user. Therefore, for example, the classification result outputting device 3180 includes a display device. Examples of the display device include a cathode ray tube (CRT) display device, a liquid crystal display (LCD) device, an organic light emitting diode (OLED) device or the like.

The transmission control model constructing device 320 has a function of determining whether transmission of sensor information is required for each sensor terminal 20 and each sensor 210 based on the communication cost of sensor information and classification accuracy by the learning discriminating processing device 310. The classification accuracy means the ratio of the number of data that are accurately classified to that of all of the data using machine learning. If the classification accuracy is high, it means the set of features of the data are valid for classifying the states. At this time, the transmission control model constructing device 320 may determine whether to transmit sensor information for each of the sensor terminal 20 and the sensor 210 by reinforcement learning. That is, the transmission control model constructing device 320 can construct a unique transmission control model for each sensor terminal 20. Further, as shown in FIG. 5, the transmission control model constructing device 320 includes a state reward processing unit 3210, a reinforcement learning processing unit 3220, and a model transfer unit 3230.

The state reward processing unit 3210 has a function of calculating a reward for each sensor terminal 20. The reward is a value that are given according to the goodness of the state after taking the action. Specifically, the state reward processing unit 3210 may calculate the reward based on the feature vector extracted from sensor information transmitted from the target sensor terminal 20. Further, the state reward processing unit 3210 may calculate the reward based on the classification result based on the feature vector. In addition, the state reward processing unit 3210 may calculate the reward based on the transmission or non-transmission state of sensor information relating to the sensor terminals 20 other than the target. In addition, the state reward processing unit 3210 may calculate the reward based on an index including the classification result and the communication cost.

The reinforcement learning processing unit 3220 has a function of obtaining a value function of actions according to the state of the observation target 10 and the reward, and constructing a control model of transmission necessity based on the value function. Details of the functions of the reinforcement learning processing unit 3220 will be described later.

The model transfer unit 3230 has a function of transmitting the transmission control model constructed by the reinforcement learning processing unit 3220 to the corresponding sensor terminal 20.

The above-described functional configuration described with reference to FIG. 5 is merely an example, and the functional configuration of the information processing apparatus 30 is not limited to this example. For example, the functions of the information processing apparatus 30 may be realized in a distributed manner by a plurality of apparatuses. Further, the data preprocessing unit 3120 and the feature vector processing unit 3130 are not necessarily required, depending on the characteristics of sensor information used for classification, algorithms or the like.

In the above description, the case where the model transfer unit 3230 transmits the constructed transmission control model to the sensor terminal 20 has been described as an example. However, the information processing apparatus 30 according to the present embodiment can perform transmission control on the sensor terminal 20 based on the transmission control model. The functional configuration of the information processing apparatus 30 is flexibly changed.

Next, the operation of the information processing apparatus 30 will be described. The operation of the information processing apparatus 30 is classified into three types of phases. The first is a learning data collection phase for collecting sensor information in each state of the observation target 10. The second is a transmission control model construction phase for constructing a transmission control model based on the above-mentioned value function. The third is a state classification phase for discriminating the state of the observation target 10 from sensor information transmitted based on the transmission control model.

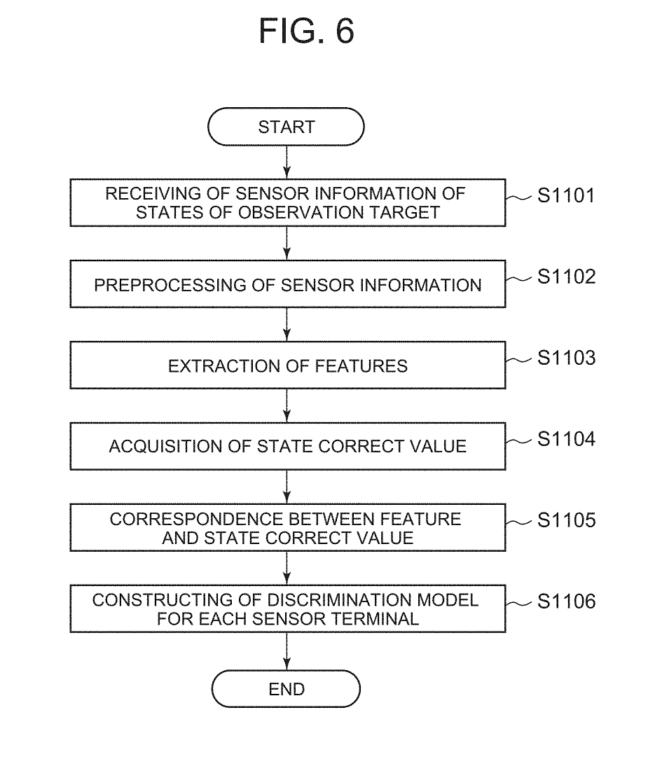

The learning data collection phase will be explained. FIG. 6 is a flowchart illustrating a flow of an operation of the information processing apparatus 30 in a learning data collection phase.

Referring to FIG. 6, in the learning data collection phase, the data receiving unit 3110 receives sensor information from a plurality of sensor terminals 20 in all states of the observation target 10 (S1101).

Next, the data preprocessing unit 3120 executes preprocessing such as frequency filtering on sensor information received in step S1101 (S1102).

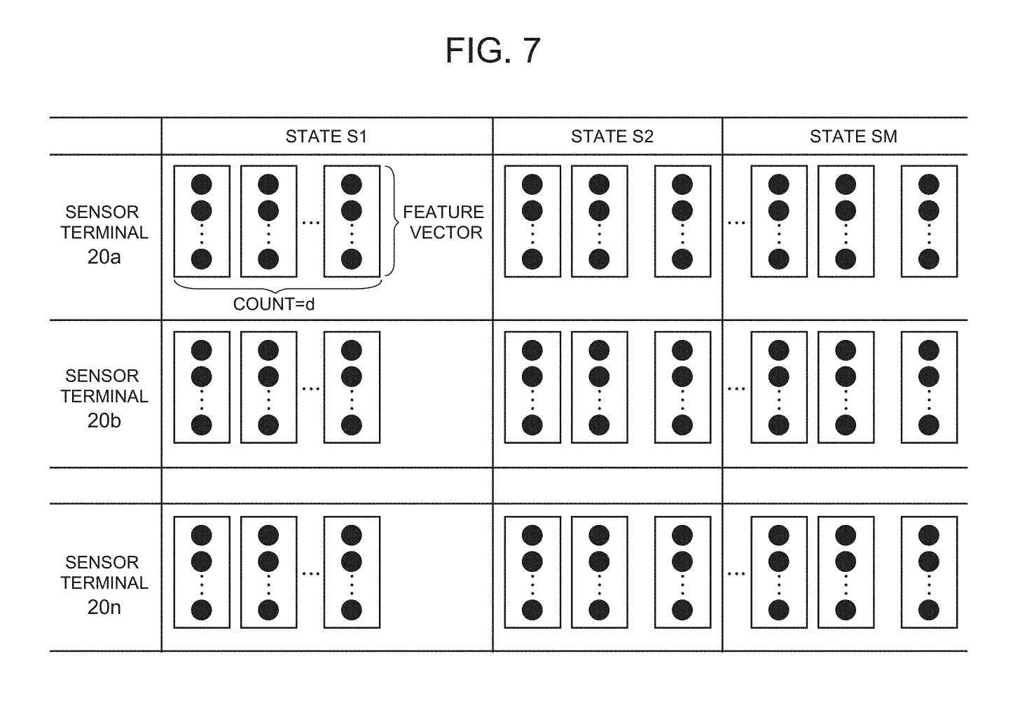

Next, the feature vector processing unit 3130 extracts feature vectors from sensor information preprocessed in step S1102 (S1103). FIG. 7 is a diagram showing feature vectors extracted by the feature vector processing unit 3130. For example, as shown in FIG. 7, when there are M kinds of observation targets 10 in the states 51 to SM, and d pieces of sensor information are acquired for one state in N sensor terminals 20, the feature vector processing unit 3130 may extract a total of d×N×M feature vectors.

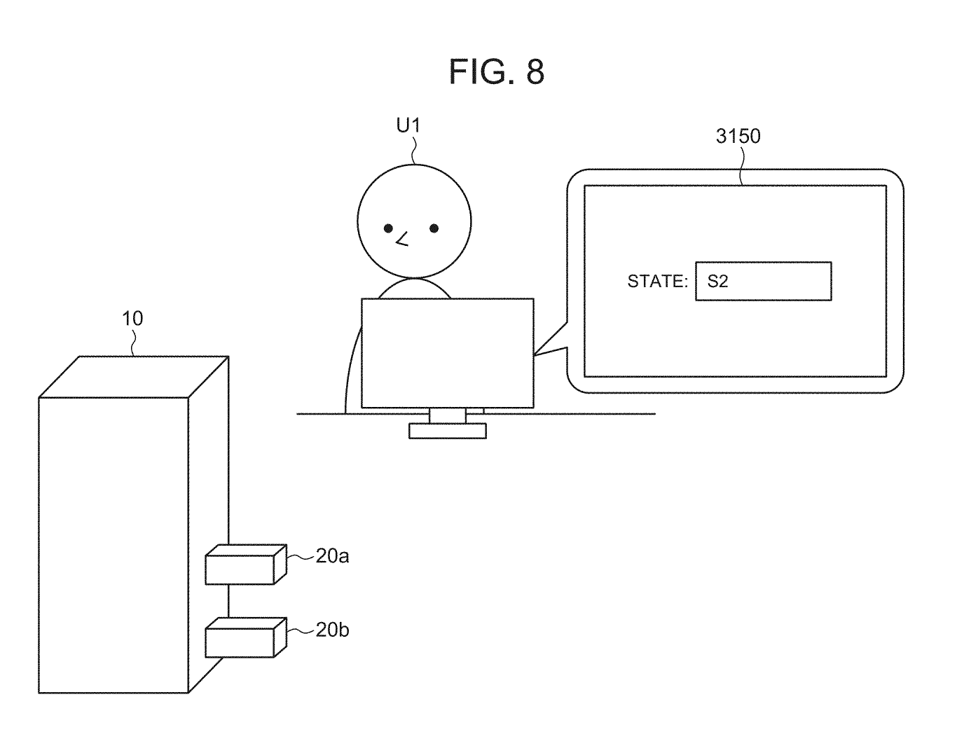

Next, the state correct value input device 3150 acquires a state correct value corresponding to the states 51 to SM of the observation target 10 input by the user (S1104). FIG. 8 is a diagram relating to an input of the state correct value. FIG. 8 illustrates the observation target 10, the plurality of sensor terminals 20a and 20b, the information processing device 30, and the user U1. As shown in FIG. 8, the user U1 may confirm the actual state of the observation target 10 by visual observation and input the state correct value related to the state to the state correct value input device 3150. At this time, for example, the user U1 may input the state correct value while acquiring sensor information relating to the state of the observation target 10. Further, for example, the user U1 may input the state correct value immediately after acquiring sensor information relating to the state of the observation target 10. Also, the user U1 may input a state correct value by pressing a button or the like associated with the state. According to the above, it is possible to correctly associate sensor information and the feature vector extracted from sensor information with the true state of the observation target 10.

Next, the learning data storage device 3160 stores in association with sensor information and the feature vector extracted in step S1103, and the state correct value acquired in step S1104 (S1105).

Next, the learning model processing unit 3140 constructs a classification model for outputting a classification result used as a reinforcement learning state in a transmission control model construction phase (to be described later) (S1106). In this case, the learning model processing unit 3140 may construct the classification model from the feature vector in each state of the observation target when only one sensor information collected from the sensor 210 of the sensor terminal 20 is used. For example, when the data receiving unit 3110 receives sensor information from N sensor terminals 20, the learning model processing unit 3140 can construct a total of N classification models.

Next, the transmission control model construction phase will be described. In the transmission control model construction phase, a transmission control model for effectively controlling the transmission of the sensor information by the sensor terminal 20 is constructed.

At this time, the transmission control model constructing device 320 according to the present embodiment can construct a transmission control model in which the necessity of transmission of sensor information is determined for each of the sensor terminal 20 and the sensor 210, based on the value function obtained by reinforcement learning. Specifically, based on the probability corresponding to the value of the value function of the necessity of transmission obtained by reinforcement learning, the transmission control model constructing device 320 may determine whether to transmit sensor information for each of the sensor terminal 20 and the sensor 210.

Reinforcement learning will now be described. Reinforcement learning is a technique to learn appropriate actions according to the situation based on the reward obtained from the environment without giving the agent correct action on the task. For example, in Q learning, which is a kind of reinforcement learning, action learning is performed by estimating a value function Q (s, a) for a combination of a state s and an action a.

For example, when the agent transits to the new state sₜ₊₁ as a result of taking the action aₜ in the state sₜ at the time t and receives the reward rₜ₊₁, the value function Q is defined by the following expression. The value function Q can be expressed as

Q(sₜ,aₜ)⇐Q(sₜ,aₜ)+a└rₜ₊₁+γmax aₜ₊₁Q(sₜ₊₁,aₜ₊₁)−Q(sₜ,aₜ)┘ (1)

“a” and “γ” in the equation (1) indicate the learning rate and the discount rate, respectively, both of which are in the range greater than 0 and less than 1. max aₜ₊₁ Q (sₜ₊₁, aₜ₊₁) means the maximum Q value when the agent takes an action aₜ₊₁ in the state sₜ₊₁. According to rₜ₊₁+γ max aₜ₊₁ Q (sₜ₊₁, aₜ₊₁)−Q (sₜ, aₜ) in the equation (1), the largest value function Q among the selectable actions in the next state is acquired. In this way, in reinforcement learning, it is possible for agents to learn strategies that maximize rewards given by the environment through a series of actions.

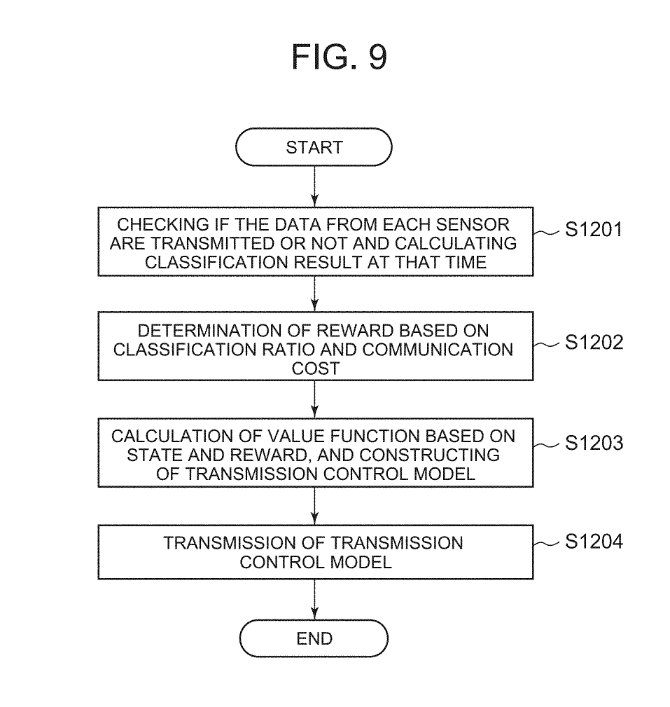

That is, in the present embodiment, it is possible to automatically learn an action model of what type of sensor information is collected and what kind of action should be performed by each sensor terminal 20 at what kind of timing. Hereinafter, the flow of the operation in the transmission control model construction phase will be described in detail. FIG. 9 is a flowchart illustrating a flow of an operation of the information processing apparatus 30 in a transmission control model construction phase.

Referring to FIG. 9, the state reward processing unit 3210 check if the data from each sensor are transmitted or not and calculating the classification result at that time (S1201).

The state reward processing unit 3210 calculates the reward to be used for the reinforcement learning processing unit 3220 (S1202). For example, when M types of states, N sensor terminals 20 and d feature vectors are obtained in the learning model processing unit 3140, a classification model is constructed by feature vectors d×M obtained from a total of N combinations of the plurality of sensor terminals 20. Then, classification accuracy rate based on each feature vector in each state is calculated. As described above, the feature vector need not be explicitly defined. For example, an algorithm capable of automatically extracting features may be used.

Also in the classification of the same state relating to the observation target 10, classification accuracy may be different depending on the combination of the sensor terminal 20 and the sensor 210 used for classification. Therefore, in the present embodiment, when the plurality of sensor terminals 20 are present, the classification model related to the state of the observation target 10 and the feature vector may be constructed by combining the sensor information received from the plurality of sensor terminals 20.

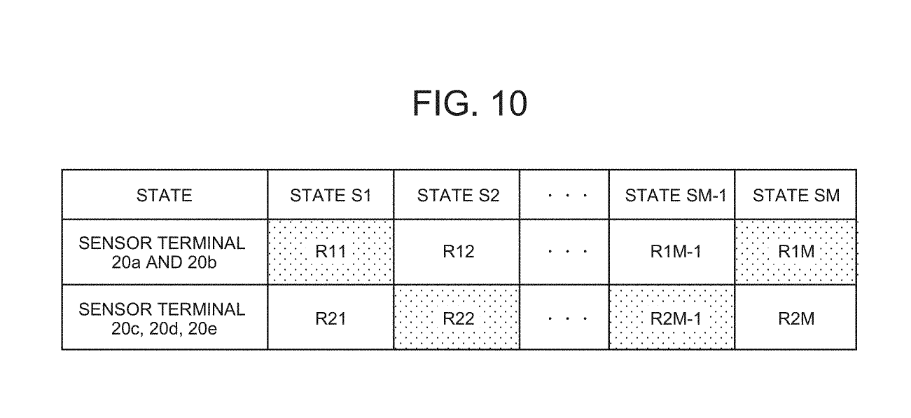

FIG. 10 is a diagram relating to a difference in classification accuracy of a combination of sensor terminals 20. FIG. 10 illustrates the classification ratios R11 to R1M and R21 to R2M of the states 51 to SM by the combination of the sensor terminals 20a and 20b, and the combination of the sensor terminals 20c to 20e. In addition, the classification ratio hatched in FIG. 10 indicates that it has a higher classification ratio as compared with the other combination.

FIG. 10 illustrates a case where the classification ratio R11 by the combination of the sensor terminals 20a and 20b has a higher value than the classification ratio R21 by the combination of the sensor terminals 20c to 20e with respect to the classification on the state 51. On the other hand, in the determination relating to the state S2, there is shown a case where the classification ratio R22 by the combination of the sensor terminals 20c to 20e has a higher value than the classification ratio R12 by the combination of the sensor terminals 20a and 20b. As described above, it is assumed that the combination of the sensor terminals 20 that maximizes the classification ratio varies depending on each state.

Therefore, in the present embodiment, a combination of the sensor terminals 20 and sensors 210 may be tried, and the classification ratio in each combination and the combination of the sensor terminal 20 and the sensor 210 with the highest classification ratio may be stored.

At this time, the state reward processing unit 3210 according to the present embodiment may determine the reward r based on r=R/C.

R indicates a classification ratio obtained by a combination of a power spectrum derived from a certain sensor terminal 20 and a sensor 210 and a power spectrum derived from the other sensor terminal 20 and a sensor 210. C indicates a total communication cost of the sensor terminal 20 related to transmission of sensor information. That is, as the classification ratio R is higher, and the communication cost C is lower, the reward r increases. Therefore, if the classification ratio R is the same, an action with a low communication cost C is more likely to be selected.

The communication cost according to the present embodiment may include at least one of the data amount of the sensor information to be transmitted or the power consumption of the sensor terminal 20 related to the transmission of the sensor information. The above data amount and power consumption are calculated based on, for example, type of sensor information, the number of sensors 210, the transmission time, the bandwidth, the radio field strength or the like.

A flow of a operation of the information processing apparatus 30 in the transmission control model construction phase will be described with reference to FIG. 9. When the reward is determined in step S1202, the reinforcement learning processing unit 3220 obtains the value function Q by repeating actions based on the state and the reward in each state of the observation target 10, and constructs a transmission control model (S1203).

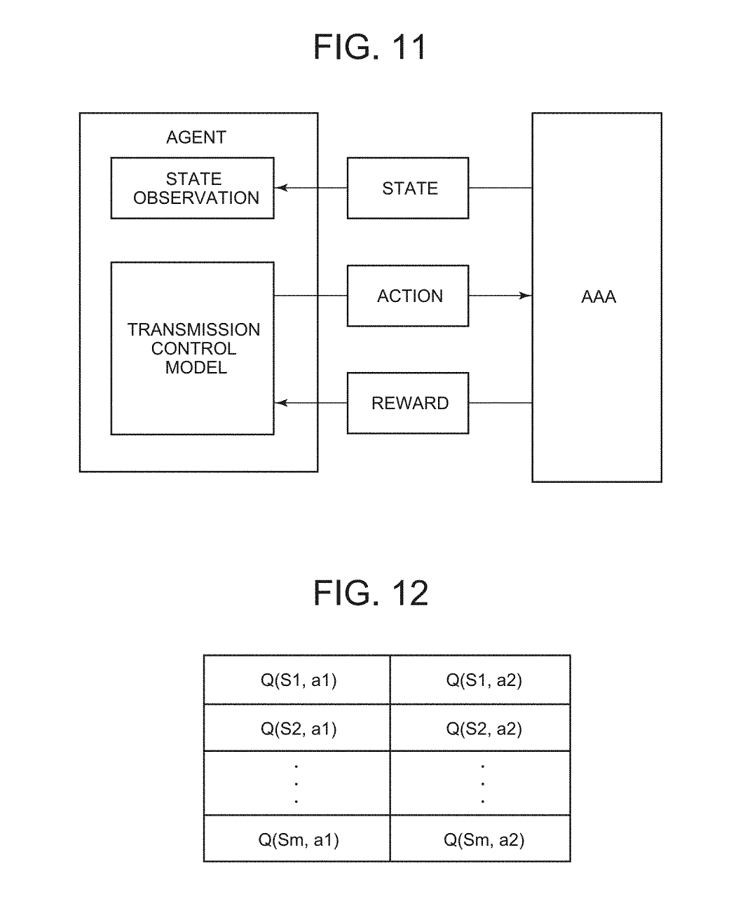

Further, FIG. 11 is a diagram illustrating an operation model of a reinforcement learning in step S1203. The state shown in FIG. 11 includes a determination result derived from each sensor terminal 20 and sensor 210, presence or absence of transmission of sensor information by another sensor terminal 20 and the like. The action shown in FIG. 11 indicates the presence or absence of transmission of sensor information for each sensor terminal 20 and each sensor 210. That is, the action shown in FIG. 11 indicates whether sensor information is to be transmitted or not. The reward in FIG. 11 may be based on the classification ratio and the communication cost. At this time, the reinforcement learning processing unit 3220 performs repeated actions until the rate of change of the value function Q converges sufficiently.

In an initial stage of the transmission control model construction phase, a combination of sensor information obtained by randomly combining the sensor terminal 20 and the sensor 210 may be set as a state. In this case, for example, the reinforcement learning processing unit 3220 can use a technique such as ε-greedy. That is, in the reinforcement learning process performed by the reinforcement learning processing unit 3220, it is possible to randomly select an action with the probability ε and select the action whose value function Q is the maximum with the probability 1−ε. In this way, by leaving the possibility of acting randomly, it is possible to prevent the estimated value function Q from falling into a local solution.

The value function Q will be described in detail. FIG. 12 is an example illustrating the value function Q at time t in a table format. As shown in FIG. 12, in the present embodiment, the state s related to the transmission state of the classification ratio and sensor information derived from each sensor terminal 20 and the value function Q (a1 and a2) for the action related to transmission/non-transmission are obtained. In this case, the number of states s is the number of states of a maximum of 2^{N}M, based on M types of classification result derived from each sensor terminal 20 and 2^{N} of the combination of actions (transmission or non-transmission) by each sensor terminal 20.

In addition, the action (transmission or non-transmission) of each sensor terminal 20 based on the constructed value function Q may be determined as follows. For example, in a certain state Sn, if the value function Q (sₙ, a₁) relating to transmission is larger than the value function (sₙ, a₂) relating to non-transmission, the agent makes a selection to transmit sensor information. If the value function (sₙ, a₂) relating to non-transmission is larger than the value function Q (sₙ, a₁) related to transmission, the agent may make a selection to non-transmit sensor information.

Further, for example, if a uniform random number from 0 to 1 is generated and the random number is less than the value of (value function related to transmission)/(sum of value functions related to transmission/non-transmission), the agent may transmit sensor information. Also, if the random number is more than the above value, the agent may non-transmit sensor information.

According to the above-described method, it is possible to construct a model having a high possibility of transmitting sensor information by a combination of the sensor terminal 20 and the sensor 210 having a high classification ratio and a low communication cost in each state of the observation target 10.

Also, when the transmission control model is constructed in step S1203 of FIG. 9, the model transfer unit 3230 transmits the transmission control model to the sensor terminal 20 (S1204).

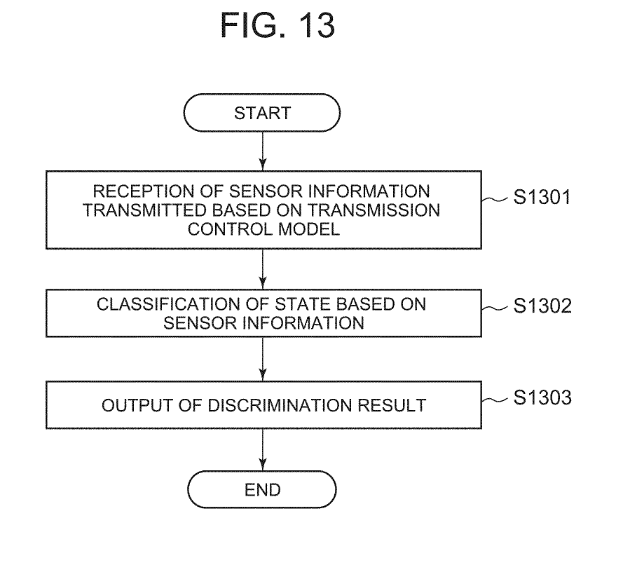

Next, the state classification phase will be described. FIG. 13 is a flowchart illustrating a flow of an operation of the information processing apparatus 30 in the state classification phase according to the first embodiment of the invention.

Referring to FIG. 13, the data receiving unit 3110 receives sensor information transmitted based on a transmission control model from the terminals 20 (S1301). At this time, the sensor terminal 20 obtains the classification result from the feature vector extracted from its own data every time, and the communication control device 230 confirms whether or not sensor information is transmitted by another sensor terminal 20. Further, the communication control device 230 selects an action (transmission or non-transmission) corresponding to the state by inputting the above information to the transmission control model, and controls transmission of sensor information.

At this time, as to the transmission state of sensor information relating to the other sensor terminal 20, the sensor terminal 20 may directly receive whether or not sensor information is transmitted by another sensor terminal 20, or may receive whether or not sensor information is transmitted via the information processing device 30.

Next, the learning model processing unit 3140 of the information processing apparatus 30 uses the classification model corresponding to the combination of the sensor terminals 20 to perform the state classification on the feature vector obtained from the sensor information of each sensor terminal 20 received in step S1301 (S1302).

Next, the classification result outputting device 3180 outputs the classification result acquired in step S1302 (S1303), and the information processing apparatus 30 returns to the sensor information waiting state.

The first embodiment according to the present embodiment has been described above. As described above, the transmission control model constructing device 320 has a function of determining whether transmission of sensor information is required for each of the sensor terminal 20 and the sensor 210, based on the communication cost of sensor information and the determination accuracy. Also, the learning classifying processing device 310 has a function of discriminating the state of the observation target based on sensor information transmitted based on the transmission necessity determined by the transmission control model constructing device.

According to the above feature of the information processing apparatus 30, even a user who does not know the optimal placement of the sensor terminal 20 can automatically select a combination of the optimum sensor terminal 20 and sensor 210 from among the arranged sensor terminals 20.

Further, according to the information processing apparatus 30, even in an environment where there are restrictions on resources such as a communication band and a battery capacity, it is possible to detect a state with high accuracy while suppressing a communication cost related to transmission of sensor information.

Further, according to the information processing apparatus 30, by suppressing the communication cost of the sensor terminal 20, it is possible to prolong the battery life and operate the system for a long time.

Further, according to the information processing apparatus 30, by suppressing transmission of unnecessary sensor information, it is possible to transfer sensor information with a high sampling frequency even with low-band wireless communication.

### (2) Second Embodiment

Next, a second embodiment of the present invention will be described. As in the first embodiment, the second embodiment of the present invention aims at optimization of classification accuracy and communication cost in state classification of the observation target 10 based on sensor information. On the other hand, the second embodiment of the present invention focuses on the construction of the value function in the case where the state in reinforcement learning cannot be definitely defined unlike the first embodiment.

The information processing apparatus 30 according to the present embodiment makes it possible to approximate a value function relating to an unknown combination by using a neural network for reinforcement learning. Specifically, the transmission control model constructing device according to the present embodiment may approximate the value function by inputting sensor information and information of the sensor terminal 20 that transmits sensor information to the neural network.

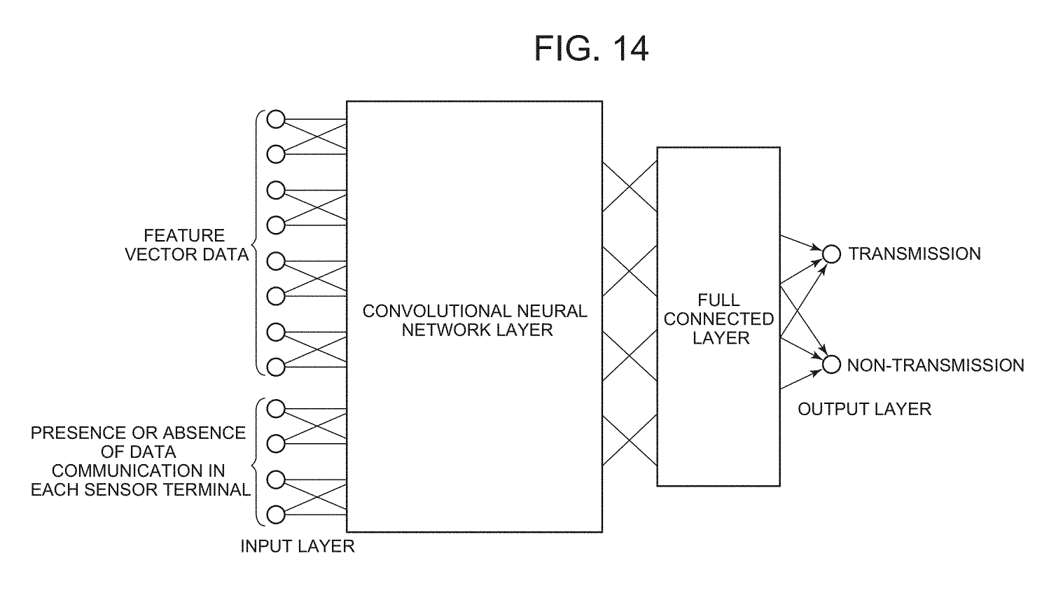

FIG. 14 illustrates a network configuration example of a neural network used for approximating a value function in constructing a transmission control model according to a second embodiment of the invention. The neural network performs an operation based on the input state and outputs the value function Q corresponding to the action of reinforcement learning. For example, Deep Q-Network (DQN) described in Document 2 may be used for the neural network. DQN is a type of deep reinforcement learning that combines convolutional neural network (CNN) and reinforcement learning. For example, as shown in FIG. 14, the neural network may be composed of an input layer, a convolutional neural network layer, a full connected layer, and an output layer.

The input layer may be input with feature vectors extracted from sensor information and information on transmission/non-transmission of sensor information in each sensor terminal 20. Also, the convolutional neural network layer may be composed of a convolution layer, a pooling layer or the like. In the pooling layer, for example, compression processing such as maximum pooling is performed. In addition, in the neural network, information abstracted by the convolutional neural network layer is input to the full connected layer, and finally the value function Q is output from the output layer.

The flow of reinforcement learning using a neural network will be described in detail. In the following description, differences from the first embodiment will be centrally described, and descriptions of configurations, functions, effects and the like that are common to the first embodiment will be omitted.

The difference between the present embodiment and the first embodiment will be described. In the first embodiment of the present invention, the classification result derived from each sensor terminal 20 is used as the state of reinforcement learning in the transmission control model construction phase. That is, it can be said that the type of state in the first embodiment is equal to the number of states of the observation target 10.

On the other hand, in the second embodiment of the present invention, a feature vector extracted from sensor information transmitted from each sensor terminal 20 may be used as a state of reinforcement learning. In this case, in the state determination phase in which transmission control is performed, a combination related to an unknown feature vector is used as a state. Therefore, in the second embodiment, a transmission control model is constructed by reinforcement learning using the neural network of the number of sensor terminals 20.

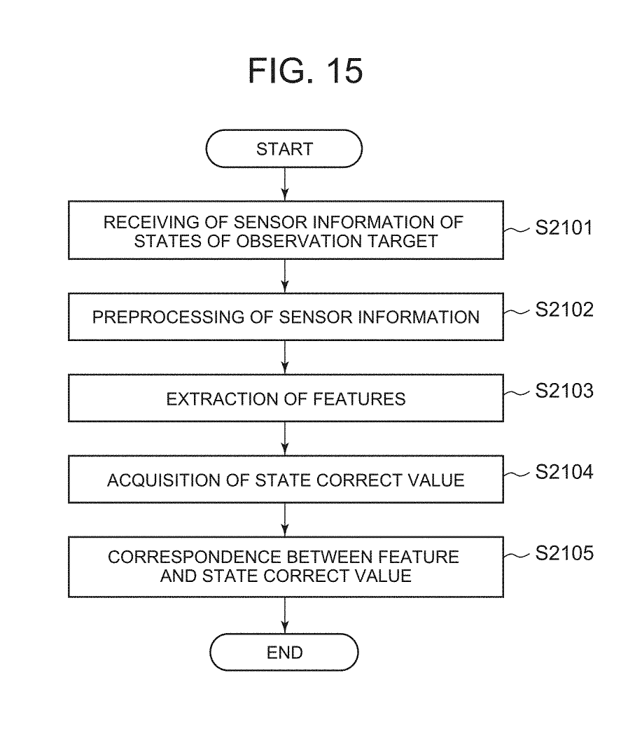

FIG. 15 is the flowchart illustrating a flow of an operation of the information processing apparatus 30 in a learning data collection phase according to the second embodiment of the invention.

In the second embodiment of the present invention, the feature vector extracted from sensor information transmitted from the sensor terminal 20 is directly used as the state of reinforcement learning, not the classification result derived from each sensor terminal 20. Therefore, in the learning data collection phase according to the second embodiment, it is unnecessary to construct the classification model performed in the learning data collection phase of the first embodiment.

Compare FIG. 15 with FIG. 6. In the second embodiment, the process of step S 1106 illustrated in FIG. 6 is not performed. For processing other than step S1106, the same processing as in the first embodiment may be performed in the second embodiment. That is, steps S2101 to S2105 according to the second embodiment correspond to steps S1101 to S 1105 according to the first embodiment, respectively.

Basically, the flow of the operation of the information processing apparatus 30 in the transmission control model construction phase and the state determination phase according to the second embodiment may be the same as in the first embodiment. On the other hand, in reinforcement learning using the neural network, for example, a feature vector such as a spectrogram extracted from sensor information transmitted from a certain sensor terminal 20 and a transmission state of sensor information relating to another sensor terminal 20 may be input.

For example, if the total number of the sensor terminals 20 is N, the number of transmission states N−1 excluding the sensor terminals to be learned target are input to the neural network according to the present embodiment. At this time, “1” may be input as the number of transmission states N−1 related to other sensor terminals 20 if sensor information is being transmitted. In addition, “0” may be input if it is not transmitted.

In the early stage of operation, sensor information may be transmitted randomly from each sensor terminal 20. According to the neural network according to the present embodiment, it is possible to construct a transmission control model that outputs the value function Q by performing actions based on the above information and acquiring rewards. The operation of the information processing apparatus 30 and the sensor terminal 20 after the transmission control model is constructed may be the same as in the first embodiment.

As described above, according to the information processing apparatus 30 related to the present embodiment, it is possible that the value function is approximated by the neural network even in an unknown situation in which the state in reinforcement learning is not clearly defined by numerical data or the like. Further, according to the information processing apparatus 30 related to the present embodiment, it is possible to estimate a value function with higher accuracy by using deep reinforcement learning.

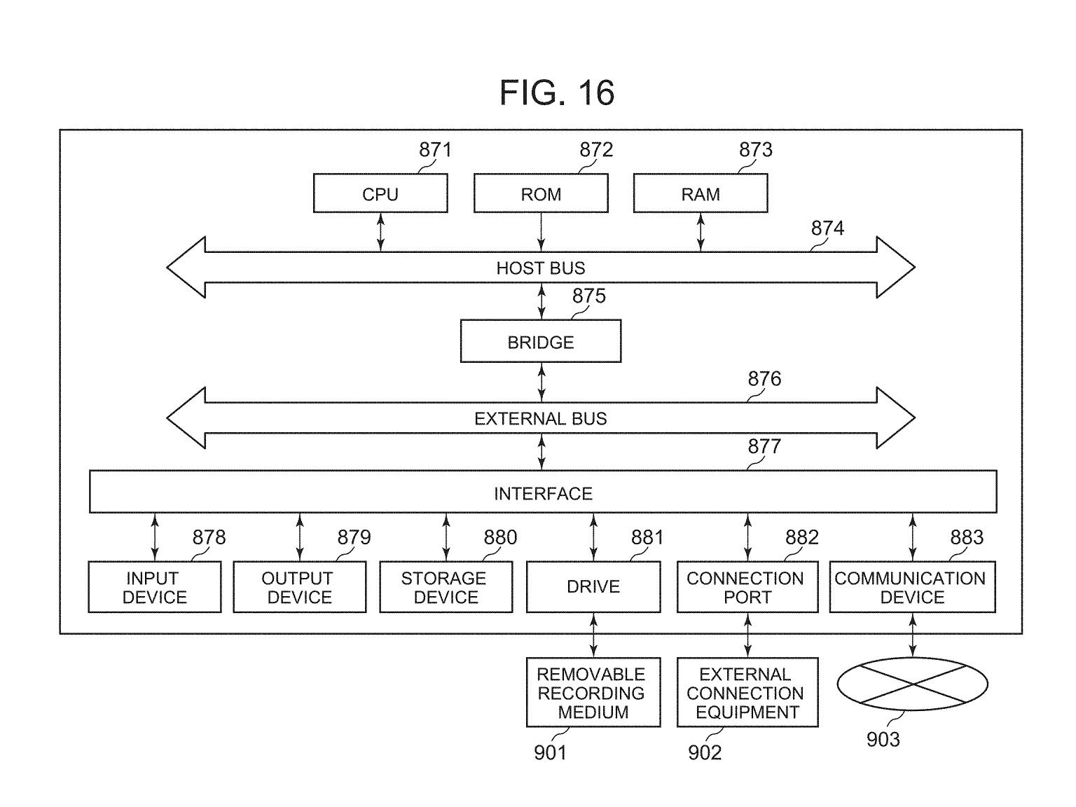

An example of a hardware configuration of the information processing apparatus 30 will be described. FIG. 16 is a block diagram illustrating a hardware configuration example of the information processing apparatus 30 according to the present invention. Referring to the FIG. 16, the information processing apparatus 30 includes, for example, a CPU 871, a ROM 872, a RAM 873, a host bus 874, a bridge 875, an external bus 876, an interface 877, an input device 878, an output device 879, a storage device 880, a drive 881, a connection port 882, and a communication unit 883. The hardware configuration is an example, and a part of the constituent elements may be omitted. It may further include constituent elements other than the constituent elements shown here.

For example, the CPU 871 functions as an arithmetic processing apparatus or a control apparatus. The CPU 871 controls the overall operation of each component or a part thereof based on various programs recorded in the ROM 872, the RAM 873, the storage device 880, or the removable recording medium 901.

The ROM 872 stores programs read into the CPU 871 and data and the like used for calculation. For example, the RAM 873 temporarily or permanently stores a program read into the CPU 871 and various parameters and the like appropriately changing when the program is executed.

The CPU 871, the ROM 872, and the RAM 873 are mutually connected via a host bus 874 capable of high-speed data transmission. On the other hand, the host bus 874 is connected to an external bus 876 having a relatively low data transmission speed via the bridge 875. Also, the external bus 876 is connected to various components via an interface 877.

The input device 878 may be a mouse, a keyboard, a touch panel, a button, a switch, a microphone, a lever or the like. Further, the input device 878 may be a remote controller capable of transmitting a control signal using infrared rays or other radio waves.

The output device 879 may be a display device such as a CRT, an LCD, an organic EL, an audio output device such as a speaker, a headphone or the like, a printer, a mobile phone, a facsimile or the like. That is, the output device 879 is a device capable of visually or audibly notifying the user of acquired information.

The storage device 880 is a device for storing various types of data. For example, the storage device 880 is a magnetic storage device such as a hard disk drive (HDD), a semiconductor storage device, an optical storage device, a magneto-optical storage device or the like.

The drive 881 may be a device that reads information recorded on a removable recording medium 901 such as a magnetic disk, an optical disk, a magneto-optical disk, a semiconductor memory or the like, or writes information to the removable recording medium 901.

The removable recording medium 901 may be a DVD medium, a Blu-ray (registered trademark) medium, an HD DVD medium, various kinds of semiconductor storage media and the like. For example, the removable recording medium 901 may be an IC card loaded with a contactless IC chip, an electronic device or the like.

The connection port 882 may be a port for connecting an external connection device 902 such as a Universal Serial Bus (USB) port, an IEEE 1394 port, a Small Computer System Interface (SCSI), an RS-232 C port, an optical audio terminal or the like.

The external connection device 902 may be a printer, a portable music player, a digital camera, a digital video camera, an IC recorder or the like.

The communication unit 883 is a communication device for connecting to the network 903. The communication unit 883 may be a communication card for wired LAN, wireless LAN, Bluetooth (registered trademark), Wireless USB (WUSB), a router for optical communication, a router for Asymmetric Digital Subscriber Line (ADSL), a modem for various communications or the like. Further, the communication unit 883 may be connected to a telephone network such as an extension telephone network or a cellular phone carrier network or the like.

As described above, the information processing apparatus 30 according to the present invention can construct the transmission control model in which the necessity for transmission of sensor information is determined for each of the sensor terminal 20 and the sensor 210 based on the communication cost of sensor information transmitted from the sensor terminal 20 and the classification accuracy based on sensor information.

Although the embodiments of the present invention have been described in detail with reference to the accompanying drawings, the present invention is not limited to such examples. It is obvious that persons having ordinary skill in the field of the technology to which the present invention belongs can conceive various modifications or modifications within the scope of the technical idea described in the claims. It is understood that these are naturally also within the technical scope of the present invention.

For example, in the above embodiment, the case where the observation target 10 is mainly a device or the like has been described as an example, but the observation target 10 according to the present invention may be an environment. For example, the information processing apparatus 30 can classify what kind of activity is being performed in the environment based on sensor information obtained in an environment such as an office or a room or the like. For the above activities, for example, walking of a person, implementation of a meeting, input operation to a keyboard or the like are assumed.

Further, in the above embodiment, the construction of the transmission control model has been described in detail. However, in the present invention, various applications may be applied to improve visibility and perception of data communication and classification results. For example, by loading a device such as an LED or the like on the sensor terminal 20 or the information processing device 30, it is possible to more intuitively present information such as transmission and reception of sensor information and a classification result to the user.

In addition, each step related to the processing of the information processing apparatus 30 related to the present invention does not necessarily need to be processed in chronological order according to the order described as a flowchart. For example, each step related to the process of the information processing apparatus 30 may be processed in an order different from the order described as a flowchart, or may be processed in parallel.

1. An information processing apparatus, comprising:
a classification device configured to classify a state of an observation target using a learning result based on sensor information received from a plurality of sensor terminals; and
a transmission control model constructing device configured to determine a necessity for transmission of sensor information for each sensor terminal based on communication cost of sensor information and classification accuracy of the classification device,
wherein the classification device classifies the state of the observation target based on sensor information transmitted based on the necessity of transmission determined by the transmission control model constructing device.

2. The information processing apparatus according to claim 1, wherein the transmission control model constructing device determines the necessity for transmission of sensor information for each sensor terminal by reinforcement learning.

3. The information processing apparatus according to claim 1, wherein the transmission control model constructing device determines the necessity for transmission of sensor information for each sensor terminal based on a value function obtained by reinforcement learning.

4. The information processing apparatus according to claim 1, wherein the transmission control model constructing device determines the necessity for transmission of sensor information for each sensor terminal based on the probability corresponding to a value function of the necessity of transmission obtained by reinforcement learning.

5. The information processing apparatus according to claim 3, wherein the transmission control model constructing device approximates the value function by using a neural network.

6. The information processing apparatus according to claim 5, wherein the transmission control model constructing device approximates the value function by inputting sensor information and information of the sensor terminal that transmits sensor information to the neural network.

7. The information processing apparatus according to claim 1, wherein the classification device classifies the state of the observation target using a learning result based on the plurality of types of sensor information received for each of the plurality of sensor terminals,
the transmission control model constructing device determines the necessity for transmission of sensor information for each of the sensor terminal and the type of a sensor.

8. The information processing apparatus according to claim 1, wherein the communication cost includes at least any one of the data amount of sensor information transmitted from the sensor terminal and a power consumption of the sensor terminal related to the transmission of sensor information.

9. A information processing method, comprising:
discriminating the state of an observation target using a learning result based on sensor information received from a plurality of sensor terminals; and
determining the necessity for transmission of sensor information for each sensor terminal based on communication cost of sensor information and classification accuracy related to the observation target,
wherein the discriminating includes discriminating the state of the observation target based on sensor information transmitted based on the necessity of transmission determined.

10. A computer-readable storage medium storing computer-executable program instructions, execution of which by a computer causes the computer to classify a state of an observation target, the program instructions comprising:
instructions to discriminating the state of an observation target using a learning result based on sensor information received from a plurality of sensor terminals; and
instructions to determining the necessity for transmission of sensor information for each sensor terminal based on communication cost of sensor information and classification accuracy related to the observation target,
wherein the discriminating includes discriminating the state of the observation target based on sensor information transmitted based on the determined necessity of transmission.
